(19) United States
(12) Patent Application Publication
(10) Pub. No.: US 2016/0131903 A1
(43) Pub. Date: May 12, 2016

(54) PREVENTING DISPLAY LEAKAGE IN SEE-THROUGH DISPLAYS

(71) Applicant: Microsoft Technology Licensing, LLC, Redmond, WA (US)

(72) Inventor: Joel S. Kollin, Seattle, WA (US)

(21) Appl. No.: 14/538,540

(22) Filed: Nov. 11, 2014

(51) Int. Cl. G02B 27/01; G02B 27/28; G02F 1/1335; G02F 1/19; G02B 1/11; G02B 27/10; G02B 5/30

(52) U.S. Cl. CPC G02B 27/0101; G02B 27/1066; G02B 27/283; G02B 5/3083; G02F 1/19; G02B 1/11; G02B 27/281; G02F 1/133528; G02B 2027/0118; G02B 2027/014; G02F 2001/13355

(57) ABSTRACT

Examples are disclosed herein that relate to reducing image leakage in a see-through display system. One disclosed example provides a see-through display system including a narrowband light source configured to emit light within a first spectral band, a polarized image producing stage configured to polarize the light emitted by the narrowband light source and to produce a polarized image, and a see-through optical system configured to receive the polarized image from the polarized image producing stage and to transfer the polarized image to a display output. The see-through optical system further includes a narrowband polarizer positioned to receive light from the narrowband light source and the polarized image producing stage, the narrowband polarizer being configured to polarize light within a second spectral band that is at least partially overlapping with the first spectral band.

### BACKGROUND

A see-through display may be used in an augmented reality display system, such as a head-mounted display or other near-eye display device, to enable the simultaneous viewing of a generated image and a real world background. A see-through display may operate by transmitting the generated image to the eye via a see-through optic through which a user also may view the real world background.

### SUMMARY

Examples are disclosed that relate to reducing image leakage in a see-through display system. One example provides a see-through display system comprising a narrowband light source configured to emit light within a first spectral band, a polarized image producing stage configured to polarize the light emitted by the narrowband light source and to produce a polarized image, and a see-through optical system configured to receive the polarized image from the polarized image producing stage and to transfer the polarized image to a display output. The see-through optical system further includes a narrowband polarizer positioned to receive light from the narrowband light source and the polarized image producing stage, the narrowband polarizer being configured to polarize light within a second spectral band that is at least partially overlapping with the first spectral band.

Another example provides a see-through display system comprising a see-through optical system including a light input interface configured to receive an input of polarized light from the polarized image producing stage, and a polarizing beam splitter positioned to receive polarized light from the light input interface. The see-through optical system further includes a variable reflector that is disposed optically downstream of the polarizing beam splitter and is configured to receive polarized light redirected by the polarizing beam splitter, wherein the variable reflector is variable between an off state in which the variable reflector is less reflective and an on state in which the variable reflector is more reflective. The see-through optical system further includes a quarter wave plate disposed optically between the variable reflector and the polarizing beam splitter, and a display output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example see-through display device, and illustrates an example of display leakage.

FIG. 2. shows a schematic depiction of an example see-through optical system.

FIG. 3. shows a schematic depiction of another example see-through optical system.

FIG. 4. shows a timing diagram illustrating an example operation of the variable reflector and image source of the example of FIG. 3.

FIG. 5 shows a flow diagram illustrating an example method of operating a see-through optical system comprising a variable reflector.

FIG. 6. shows another example see-through optical system for a see-through display.

FIG. 7 shows a block diagram of an example of a computing system.

### DETAILED DESCRIPTION

As mentioned above, a see-through display system may be configured to allow the simultaneous viewing of a generated image and at least a portion of a real world background. Some see-through display systems may deliver generated images to a user's eye by utilizing a see-through optical component, such as a waveguide or prism, which contains one or more selectively or partially reflective or refractive optical elements. An image may be coupled into the waveguide or prism at a location to a side of a viewer's field of view, and then coupled out and toward a user's eye via the reflective or refractive optical element(s), thereby mixing the generated image with the real world background.

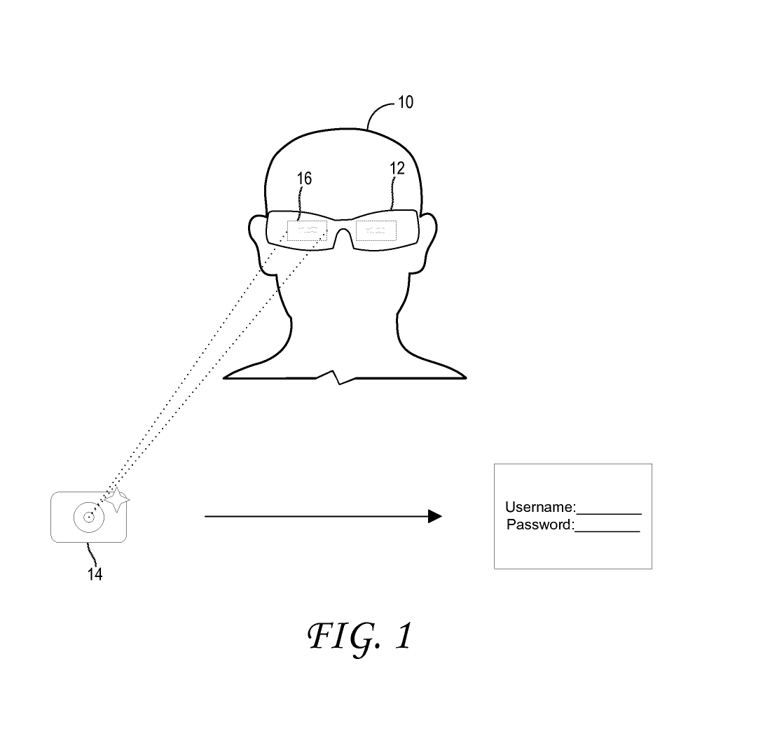

However, some light may be reflected in a direction away from a user's eye by these and/or other components and instead toward an outward-facing surface of the see-through optical component, and thus may be visible to outside viewers. This effect may be referred to as display leakage. Display leakage may be undesirable, as it may compromise the privacy of a user of a see-through display. For example, an image viewable due to display leakage may be recorded (e.g. via still or video image capture), unbeknownst to the wearer of the near-eye display, to allow private information, such as passwords, account information, etc. to be viewed without authorization. FIG. 1 illustrates an example of such a scenario, in which a user 10 wearing a head-mounted see-through display 12 is photographed by camera 14 to capture private information that is viewable due to display leakage 16. The images of the display may then be processed to reveal potentially private information.

With some see-through display systems, private information may be viewed by capturing a single image of a see-through display and enhancing the image (e.g. by enlarging the image and/or performing other suitable processing techniques). With other systems, multiple images may be captured and then combined to see the image displayed to the wearer of the device.

In view of the above, examples are disclosed herein that may help address such issues. It will be understood that one or more of the disclosed examples may be used in an implementation of a see-through display device, depending upon an optical system used to present the generated image.

Some see-through display devices may utilize a prism or light guide having a beam splitter positioned in front of a user's eye, wherein the beam splitter directs a generated image out of the prism or light guide and toward the user's eye. However, the beam splitter also may direct some light away from the user's eye toward an outward-facing surface of the prism or light guide, thereby producing display leakage.

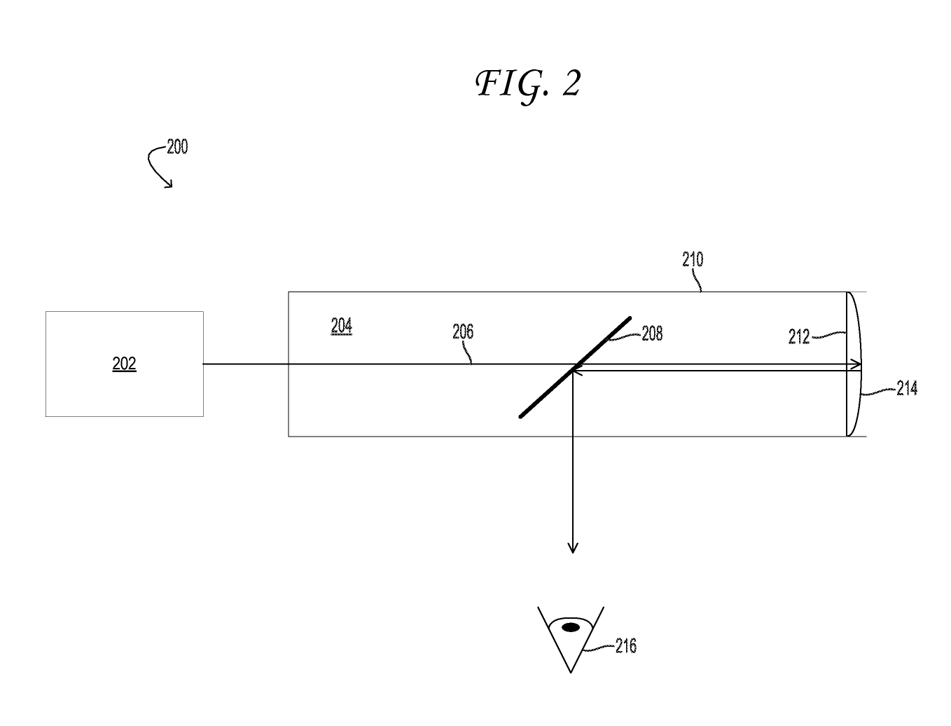

Thus, such a see-through display system may utilize a polarizing beam splitter in combination with a polarized image producing stage to help avoid display leakage. FIG. 2 shows one example of a see-through display system 200 that utilizes a polarizing beam splitter in combination with a polarized image producing stage to display augmented reality imagery. See-through display system 200 includes a polarized image producing stage 202 configured to produce a polarized image 206, a see-through optical system 204 configured to transfer the polarized image 206 received from polarized image producing stage 202 to a display output, and a polarizing beam splitter 208 positioned in the see-through optical system 204 at a location configured to be within a user's field of view when wearing the device.

In the configuration of FIG. 2, polarized light 206 received from the polarized image producing stage 202 initially has a polarization state that is configured to pass through the polarizing beam splitter 208 without being redirected by the polarizing beam splitter 208. As the light is already polarized, little to no light is reflected by the polarizing beam splitter 208 toward an outward-facing surface 210 of the see-through optical system 204, thus helping to reduce display leakage compared to the use of unpolarized light and/or a different type of beam splitter.

After passing through the polarizing beam splitter 208, the polarized light 206 passes through quarter wave plate 212, and is then reflected by a reflector 214 and directed back through quarter wave plate 212. The two passes through the quarter wave plate 212 rotate the polarization of the light such that the light is reflected by the polarizing beam splitter 208 towards a user's eye 216.

While the example of FIG. 2 helps to avoid display leakage, the polarizing beam splitter 208 may reduce the intensity of the light coming in from the real world background. As such, the view of the real world background in the area of the see-through optical system occupied by the polarizing beam splitter 208 from a viewer's perspective may look dimmer than surrounding areas of the background scene.

To help mitigate such issues, polarizing beam splitter 208 may be implemented as a narrowband polarizer, and the polarized image producing stage 202 may be configured to produce an image using one or more narrowband light sources. The narrowband light source(s) may be configured to emit light within a first spectral band or first set of spectral bands, and the narrowband polarizer may be configured to reflect polarized light within a second spectral band (or second set of spectral bands) that at least partially overlaps with the first spectral band or set of spectral bands. In some examples, the first and second spectral bands (or first and second sets of spectral bands) may substantially or fully overlap. Thus, the portion of the first spectral band(s) emitted by the light source that overlaps with the second spectral band(s) reflected by the polarizing beam splitter 208 is directed to the user's eye 216 as shown in FIG. 2. As such, the narrowband polarizer may allow background light outside of the second spectral band or bands to pass through towards the user's eye 216 with less reduction in brightness than use of a broadband polarizer that polarizes all visible light. This may help to reduce dimming of light from the real world background compared to the use of a broadband polarizer.

The narrowband light source may comprise any suitable light source, including but not limited to a narrowband emissive light source such as colored LEDs, laser diodes, quantum dot emitters, and organic light emitting device(s). Further, the narrowband light source may comprise a wider band light source, such as a white LED system, in combination with a color filter arrangement.

The polarized image producing stage 202 may comprise any suitable image producing system. For example, the polarized image producing stage 202 may comprise a spatial light modulator, such as a liquid crystal display (LCD) or liquid crystal on silicon (LCOS) display, in combination with one or more LEDs, laser diodes, and/or other light sources. As a liquid crystal and LCOS displays produce polarized images, a separate polarization filter may be omitted in such examples. In other examples, the polarized image producing stage may comprise an emissive image producing element, such as an OLED display. In such examples, a polarizing filter may be used optically downstream of the emissive display to polarize light from the emissive display prior to the light reaching the polarizing beam splitter.

The polarizing beam splitter 208 may utilize any suitable type of polarizer. Examples include, but are not limited to, wire-grid polarizers and multi-layer thin film polarizers.

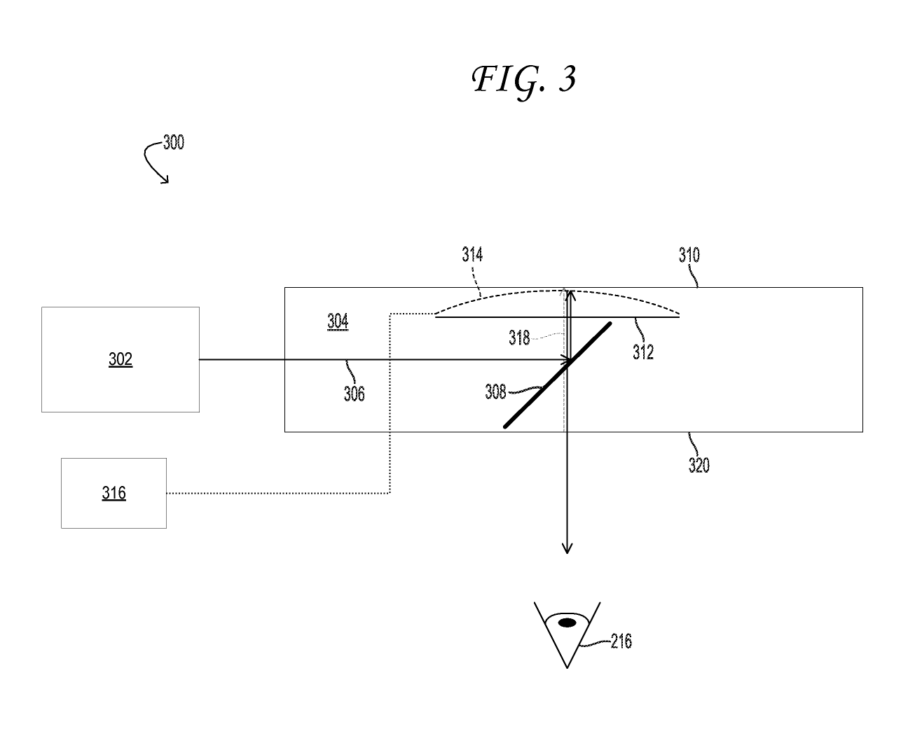

In the example of FIG. 2, reflector 214 and quarter wave plate 212 of see-through display system 200 are positioned to a side of the polarizing beam splitter 208 from the perspective of a user of the display system, as polarizing beam splitter 208 is configured to transmit the polarized light 206 received from the polarized image producing stage 202. However, in other examples, the polarizing beam splitter may be configured to reflect polarized light 206 received from the polarizing image producing stage. FIG. 3 shows an example see-through display system 300 in which the reflector 314 and quarter wave plate 312 are positioned between a user's eye and the real world background. As such, polarizing beam splitter 308 reflects polarized light 306 received from polarized image producing stage 302 toward the reflector 314 and quarter wave plate 312, and then transmits light received from the reflector 314 and quarter wave plate 312 toward a user's eye when the device is worn. In this configuration, the reflector 314 reflects light received from the polarizing beam splitter 308, and thus helps to avoid display leakage.

However, in the configuration of FIG. 3, the reflector 314 may interfere with a user's view of the background world through the see-through display system 300. Thus, to help prevent such interference with the real world background view, the reflector 314 may be implemented as a variable reflector that is variable between an OFF state in which it is less reflective and an ON state in which it is more reflective. In the OFF state, variable reflector 314 is less reflective, and may be substantially non-reflective in some examples. Thus, in this state, the variable reflector 314 may permit a clear view of the background world. On the other hand, in the ON state, variable reflector 314 is more reflective, and reflects the polarized light provided by polarized image producing stage 302. In some implementations, the quarter wave plate 312 alternatively or additionally may be variable, such that the quarter wave plate rotates polarized light when in a first state, and does not rotate polarized light (or rotates the polarized light to a lesser degree) in a second state. In such implementations, the reflector 314 may or may not be variable.

The use of a variable reflector 314 allows the reflector to be turned on when the polarized image producing stage 302 is producing an image for display, and turned off otherwise. As such, to produce an augmented reality image, the see-through display system 300 may synchronously modulate the operating states of the polarized image producing stage 302 and the variable reflector 314 at a sufficient frame rate for the human eye to blend the generated image and the real-world background view. When the variable reflector 314 and polarized image producing stage 302 are in the OFF state (e.g. the polarized image producing stage is not outputting a display image) the user may view the real-world background through the polarized beam splitter 308 and variable reflector 314. Likewise, when the variable reflector 314 and polarized image producing stage 302 are in the ON state, the user may view the generated image.

The see-through display system 300 further includes a computing device 316 configured to control the synchronous operation of the polarized image producing stage 302 and variable reflector 314 (and, in some implementations, a variable quarter wave plate optionally used as quarter wave plate 312). More specifically, the computing device 316 includes a logic subsystem and a storage subsystem storing instructions executable by the logic subsystem to synchronously change the operating states of the variable reflector 314 and polarized image producing stage 302 as described herein.

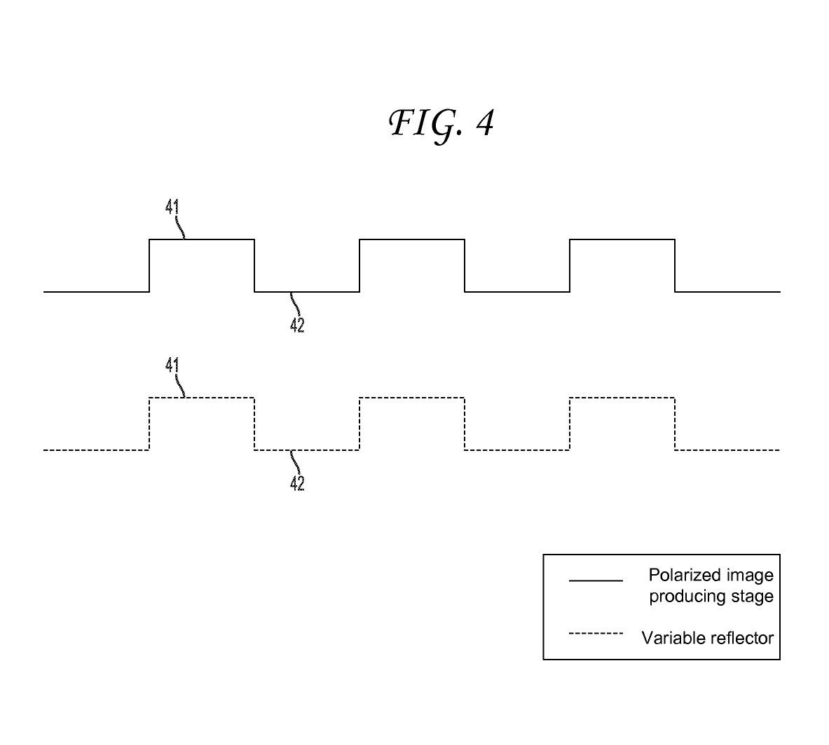

FIG. 4 shows an example timing diagram illustrating the synchronous modulation of the operating states of variable reflector 314 and polarized image producing stage 302. As explained above, computing device 316 synchronously changes variable reflector 314 to the ON state 41 whenever polarized image producing stage 302 is also in the ON state 41, and to the OFF state 42 whenever polarized image producing stage 302 is also in the OFF state 42.

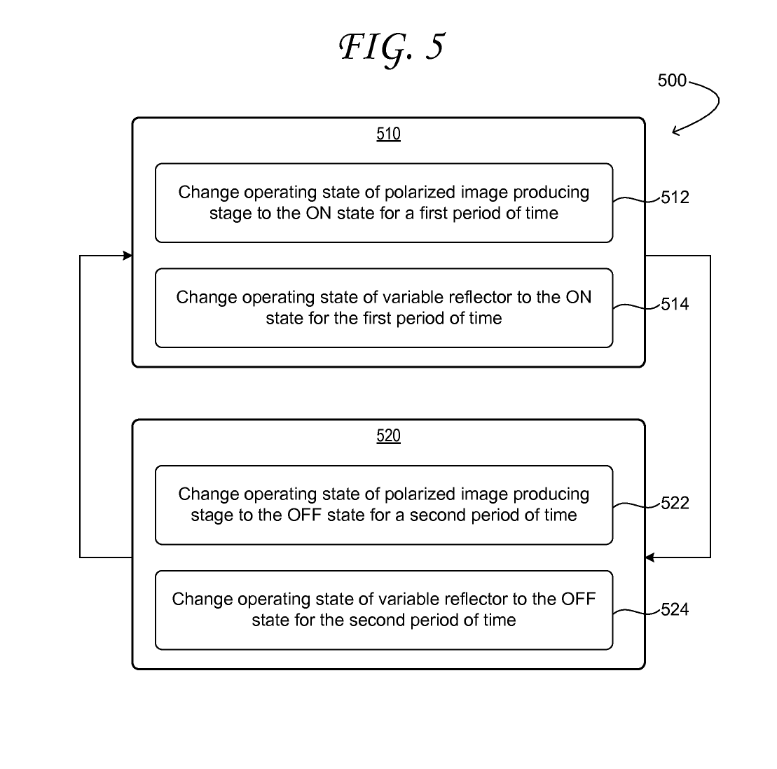

FIG. 5 shows a flow diagram illustrating an example method 500 for the synchronous operation of variable reflector 314 and polarized image producing stage 302 via computing device 316. At 510, computing device 314 changes the operating state of polarized image producing stage 302 to the ON state at 512 and also changes the operating state of variable reflector 314 to the ON state at 514 for a first period of time. At 520, computing device 316 changes the operating state of polarized image producing stage 302 to the OFF state at 522 and also changes the operating state of variable reflector 314 to the OFF state at 524 for a second period of time. Computing device 316 thus cycles between 510 and 520 to synchronously change the operating states of polarized image producing stage 302 and variable reflector 314 between the ON and OFF states.

The ON and OFF states may be cycled at any suitable frequency, and may have any suitable relative duration, which may or may not be equal in various implementations. Further, in some implementations, the relative timing of the ON and OFF states may vary during use, for example, to adjust to ambient lighting conditions as determined via sensor data, such as from an outward-facing (e.g. facing away from the viewer) image sensor or other light sensor.

The variable reflector may utilize any suitable variable reflective technology. Examples include, but are not limited to, reflective polarizers using active liquid crystals, switchable polymer-dispersed liquid crystal optical elements, and polymer liquid crystal polymer slices (POLICRYPS)/polymer liquid crystal polymer holograms electrically manageable (POLIPHEM) thin layer polymer/liquid crystal switchable devices.

In some instances, light redirected via reflections or refractions at component interfaces within the see-through optical system may be visible as display leakage, even where the polarizing structures described above are employed. For example, referring again to FIG. 3, light 318 from an image produced by polarized image producing stage 302 may reflect from a viewer-facing surface 320 of see-through optical system 304 and toward an outward-facing surface 310, where it may be visible as display leakage. Accordingly, a polarizer may be applied to outward-facing surface 310 of the see-through optical system 304, wherein the polarizer is arranged to attenuate transmission of a generated image through outward-facing surface 310. Such a polarizer may be implemented as a narrow band polarizer used in conjunction with one or more narrow band light sources, as described above.

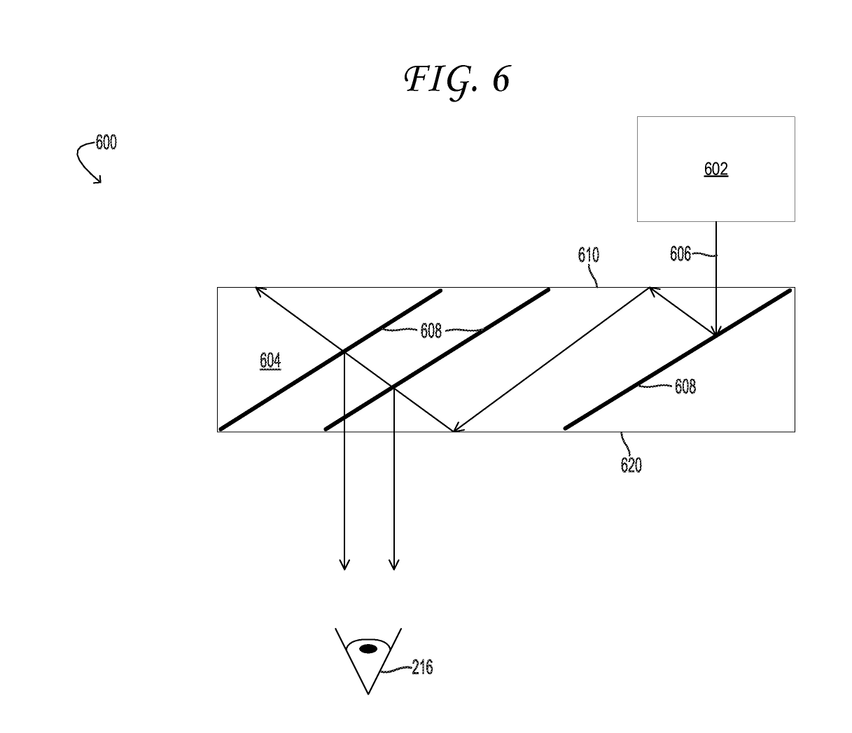

In the examples of FIG. 2 and FIG. 3, see-through display systems 200 and 300 each utilizes a polarizing beam splitter to direct light from a polarized image producing stage to a user's eye. However, in other examples, one or more other components may be utilized to achieve the same effect. For example, FIG. 6 shows an example of a see-through display system 600 that includes polarized image producing stage 602 and utilizes one or more partially reflective interfaces 608 in see-through optical system 604 (and a plurality of interfaces in some implementations), wherein each partially reflective interface is configured to direct a portion of polarized image 606 toward a viewer-facing surface 620 of the see-through optical system 604. It will be understood that such a see-through display system may include any suitable number of partially reflective interfaces 608 and is not limited to the number and placements of those shown in FIG. 6.

In the example of FIG. 6, a viewer-facing surface 620 of the see-through display system 600 may reflect a portion of light received from image producing stage 602 away from the user's eye 216, which may result in display leakage. Accordingly, to avoid such leakage, see-through display system 600 may further comprise an anti-reflective coating on viewer-facing surface 620. Such an anti-reflective coating may be configured to have Fresnel reflection losses of less than five percent in some examples, and less than one percent in other examples. It will be understood that such an antireflective film may also be used with the examples of FIGS. 2 and 3, and any other suitable see-through display system.

As additional protection against display leakage, the see-through display system 600 may further include a polarizer located on an outward-facing surface 610 of the see-through optical system 600 that is opposite the viewer-facing surface 620, as described above. The see-through optical system 600 also may utilize a narrowband light source and a narrowband polarizer to help reduce any dimming of the appearance of the real world background by the polarizer, as described above.

The methods and processes described herein may be tied to a computing system of one or more computing devices, such as the see-through display devices described herein. For example, the methods and processes described herein may be implemented as a computer-application program or service, an application-programming interface (API), a library, and/or other computer-program product.

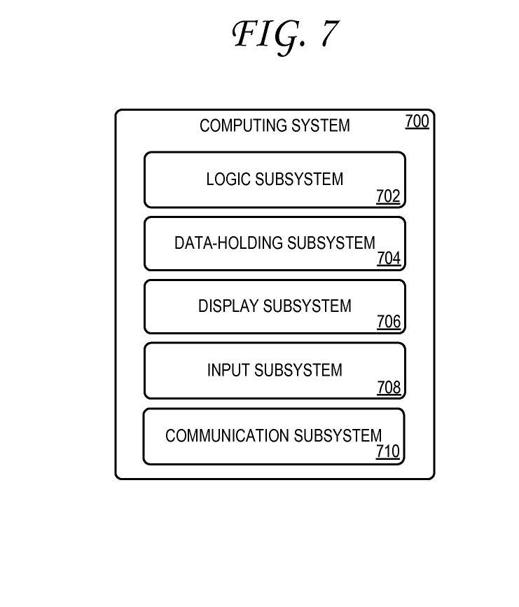

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), wearable computing devices, and/or other computing devices. It is to be understood that any suitable computer architecture may be used without departing from the scope of this disclosure.

Computing system 700 includes a logic subsystem 702 and a data-holding subsystem 704. Computing system 700 may optionally include a display subsystem 706, input subsystem 708, communication subsystem 708, and/or other components not shown in FIG. 7. Computing system 700 may also optionally include user input devices such as keyboards, mice, cameras, microphones, and/or touch screens, for example.

Logic subsystem 702 may include one or more physical devices configured to execute instructions. For example, logic subsystem 702 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 702 may include one or more processors configured to execute software instructions. Additionally or alternatively, logic subsystem 702 may include one or more hardware or firmware logic machines configured to execute hardware or firmware instructions. Processors of logic subsystem 702 may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of logic subsystem 702 may be virtualized and executed by remotely accessible, networked computing devices configured in a cloud-computing configuration.

Data-holding subsystem 704 may include one or more physical devices configured to hold instructions executable by logic subsystem 702 to implement the methods and processes described herein. When such methods and processes are implemented, the state of data-holding subsystem 704 may be transformed—e.g., to hold different data.

Data-holding subsystem 704 may include removable and/or built-in devices. Data-holding subsystem 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Data-holding subsystem 704 may include volatile, nonvolatile, dynamic, static, read/write, read-only, random-access, sequential-access, location-addressable, file-addressable, and/or content-addressable devices.

It will be appreciated that data-holding subsystem 704 includes one or more physical devices. However, aspects of the instructions described herein alternatively may be propagated by a communication medium (e.g., an electromagnetic signal, an optical signal, etc.), as opposed to being stored by a storage device.

Aspects of logic subsystem 702 and data-holding subsystem 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 706 may be used to present a visual representation of data held by data-holding subsystem 704. This visual representation may take the form of a graphical user interface (GUI), an augmented reality image, or other suitable generated image. As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic subsystem 702 and/or data-holding subsystem 704 in a shared enclosure, or such display devices may be peripheral display devices.

Input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A see-through display system, comprising:
a narrowband light source configured to emit light within a first spectral band;
a polarized image producing stage configured to polarize the light emitted by the narrowband light source and to produce a polarized image;
a see-through optical system configured to receive the polarized image from the polarized image producing stage and to transfer the polarized image to a display output; and
a narrowband polarizer positioned to receive light from the narrowband light source and the polarized image producing stage, the narrowband polarizer being configured to polarize light within a second spectral band that is at least partially overlapping with the first spectral band.

2. The system of claim 1, wherein the see-through optical system comprises a polarizing beam splitter configured to receive light from the narrowband light source and the polarized image producing stage.

3. The system of claim 2, further comprising a variable reflector disposed optically downstream of the polarizing beam splitter, the variable reflector being positioned to receive polarized light from the polarized image producing stage that is reflected by the polarizing beam splitter, and to be variable between an off state in which the variable reflector is less reflective and an on state in which the variable reflector is more reflective.

4. The system of claim 2, wherein the narrowband polarizer is incorporated in the polarizing beam splitter.

5. The system of claim 2, further comprising a quarter wave plate disposed optically between the variable reflector and the polarizing beam splitter.

6. The system of claim 1, further comprising a plurality of partially reflective interfaces in the see-through optical system, each partially reflective interface configured to direct a portion of the polarized image toward a viewer-facing surface of the see-through optical system.

7. The system of claim 6, further comprising an anti-reflective coating on the viewer-facing surface of the see-through optical system, the anti-reflective coating configured to have Fresnel reflection losses of less than one percent.

8. The system of claim 6, wherein the narrowband polarizer is incorporated in one or more of each of the plurality of partially reflective interfaces and/or in a polarizer located on an outward-facing surface of the see-through optical system, the polarizer located on the outward-facing surface configured to attenuate polarized light within the second spectral band.

9. The system of claim 1, wherein the narrowband light source comprises a narrowband emissive light source.

10. A see-through display system, comprising:
a see-through optical system comprising
a light input interface configured to receive an input of polarized light from a polarized image producing stage;
a polarizing beam splitter positioned to receive polarized light from the light input interface;
a variable reflector disposed optically downstream of the polarizing beam splitter, the variable reflector being configured to receive polarized light redirected by the polarizing beam splitter, and to be variable between an off state in which the variable reflector is less reflective and an on state in which the variable reflector is more reflective;
a quarter wave plate disposed optically between the variable reflector and the polarizing beam splitter; and
a display output located to emit light that has been reflected by the variable reflector that passes through the polarizing beam splitter to the display output.

11. The system of claim 10, further comprising a logic subsystem and a storage subsystem storing instructions executable by the logic subsystem to synchronously change the operating states of the variable reflector and the polarized image producing stage.

12. The system of claim 10, wherein the see-through optical system further comprises an outward facing surface and a polarizer applied to the outward facing surface, the polarizer applied to the outward facing surface being arranged to attenuate transmission of an image produced by the polarized image producing stage out of an outward facing side of the see-through optical system.

13. The system of claim 10, further comprising a narrowband light source, the narrowband light source being configured to provide light to the polarized image producing stage.

14. The system of claim 13, wherein the narrowband light source is configured to emit light within a first spectral band, and wherein the polarizing beam splitter is configured to reflect polarized light within a second spectral band that is at least partially overlapping with the first spectral band.

15. A see-through display system, comprising:
a polarized image producing stage;
a see-through optical system configured to transfer a polarized image received from the polarized image to a display output;
one or more partially reflective interfaces in the see-through optical system, each partially reflective interface configured to direct a portion of the polarized image toward a viewer-facing surface of the see-through optical system; and
an anti-reflective coating on the viewer-facing surface of the see-through optical system, the anti-reflective coating configured to have Fresnel reflection losses of less than five percent.

16. The system of claim 15, wherein the anti-reflective coating is configured to have Fresnel reflection losses of less than one percent.

17. The system of claim 15, further comprising a polarizer located on an outward-facing surface of the see-through optical system that is opposite the viewer-facing surface.

18. The system of claim 15, further comprising a narrowband light source, the narrowband light source being configured to provide light to the polarized image producing stage and to emit light within a first spectral band.

19. The system of claim 18, further comprising a polarizer located on an outward-facing surface of the see-through display, wherein the polarizer located on the outward-facing surface of the see-through optical system is configured to attenuate transmission of polarized light within a second spectral band that is at least partially overlapping with the first spectral band more strongly than polarized light outside of the second spectral band.

20. The system of claim 18, wherein one or more of the plurality of partially reflective interfaces is configured to reflect polarized light within a second spectral band that is at least partially overlapping with the first spectral band.
